(19) United States
(12) Patent Application Publication
(10) Pub. No.: US 2016/0122561 A1
(43) Pub. Date: May 5, 2016

(54) MULTILAYER COATING FILM AND COATED ARTICLE

(71) Applicant: MAZDA MOTOR CORPORATION, Hiroshima (JP)

(72) Inventors: Hidekazu KATO, Aki-gun, Hiroshima (JP); Kana HARUKI, Aki-gun, Hiroshima (JP); Naoto WAKU, Hiroshima-shi, Hiroshima (JP)

(73) Assignee: MAZDA MOTOR CORPORATION, Hiroshima (JP)

(21) Appl. No.: 14/889,724

(22) PCT Filed: Jul. 16, 2014
(86) PCT No.: PCT/JP2014/003780

§ 371 Date: Nov. 6, 2015

(30) Foreign Application Priority Data
Sep. 30, 2013 (JP) 2013-204421

(51) Int. Cl. C09D 5/32; B05D 5/00; C09D 7/12; B05D 7/00

(52) U.S. Cl. CPC C09D 5/32; B05D 7/54; B05D 5/00; C09D 7/1216

(57) ABSTRACT

This multilayer coating film includes a first coat 5 containing a coloring material and a second coat 6 stacked on the first coat 5. The first coat 5 contains metallic oxide nanoparticles 9 having an ultraviolet interception effect. The second coat 6 contains at least one of the metallic oxide nanoparticles having an ultraviolet interception effect or an organic ultraviolet absorber having an ultraviolet interception effect.

### TECHNICAL FIELD

The present invention relates to a multilayer coating film and a coated article.

### BACKGROUND ART

In coating of metal products, such as outer plates of a vehicle body, which requires weather resistance, a coating structure has been widely adopted where an undercoat made of rust-preventing electrodeposition paint, an intermediate coat having the ability to conceal the undercoat, and a topcoat (a base coat and a clear coat) are stacked in sequence. In order to, e.g., save resources, an attempt has also been made to stack a topcoat directly on an undercoat without an intermediate coat. For example, a base coat having the ability to conceal an undercoat is formed on a cationic electrodeposition coat, and a clear coat is formed on this base coat.

If an undercoat, in particular, an undercoat made of epoxy-based cationic electrodeposition paint is exposed to a large amount of ultraviolet radiation, its surface portion is deteriorated and the coat on top of the undercoat is peeled off. An ultraviolet absorber is typically added to an intermediate coat and/or a topcoat to protect the undercoat from ultraviolet light.

Known examples of the ultraviolet absorber include various organic compounds such as benzotriazole- and benzophenone-based compounds. Such organic ultraviolet absorbers absorb ultraviolet light by converting ultraviolet energy into thermal energy or by receiving ultraviolet light and temporarily changing the molecule structure. Nanoparticles of metallic oxide such as zinc oxide and titanium oxide disclosed in Patent Document 1 have also been known, in addition to the ultraviolet absorber, as additives that are effective at intercepting ultraviolet light. These nanoparticles absorb ultraviolet light by exciting electrons within the valence band to the conduction band or block ultraviolet light by scattering and reflecting the ultraviolet light.

### CITATION LIST

### Patent Document

PATENT DOCUMENT 1: Japanese Unexamined Patent Application Publication (Japanese Translation of PCT Application) No. 2012-530671

### SUMMARY OF THE INVENTION

### Technical Problem

As described above, the above organic ultraviolet absorbers have a problem where the heat generation or the temporary change in molecule structure takes place repeatedly due to absorption of ultraviolet light, thereby gradually destroying the molecule structure to deteriorate the absorber. As a result, its ultraviolet interception effect is reduced. Further, polishing of a coat made of an ultraviolet absorber of this kind, which has a large particle size, not only reduces the content of the ultraviolet absorber, but also partially destroys the structure of the ultraviolet absorber remaining in the coat. As a result, the ultraviolet interception effect of the ultraviolet absorber is significantly reduced. On the other hand, the above metallic oxide nanoparticles are hardly deteriorated by ultraviolet light. In addition, although polishing of a coat reduces the content of the nanoparticles themselves, the structure of the nanoparticles remaining in the coat is not damaged by the polishing. As a result, the ultraviolet interception effect of the nanoparticles is not significantly reduced.

Thus, the nanoparticles may be added to a coat instead of an organic ultraviolet absorber. However, too much addition of the particles tends to allow the coat to be opaque, resulting in deterioration of coloring properties. Too large thickness of the base coat improves the ultraviolet interception effect. However, this makes it difficult to obtain desired coloring properties.

It is therefore an object of the present invention to obtain an excellent ultraviolet interception effect of a coat without deteriorating coloring properties of the coat.

### Solution to the Problem

In order to attain the object, the present invention provides a multilayer coating film comprised of a lower coat and an upper coat. In this coating film, oxide nanoparticles (particles having a size of 1 nm to 100 nm) with an ultraviolet interception effect are added to the lower coat, and the nanoparticles and/or an organic ultraviolet absorber are added to the upper coat.

That is, the multilayer coating film disclosed herein includes a first coat provided on or above an undercoat and containing a coloring material; and a second coat stacked on the first coat. The first coat contains metallic oxide nanoparticles having an ultraviolet interception effect. The second coat contains at least one of metallic oxide nanoparticles having an ultraviolet interception effect or an organic ultraviolet absorber having an ultraviolet interception effect.

According to the configuration of the multilayer coating film, both the ultraviolet intercepting nanoparticles in the first coat and the intercepting nanoparticles and/or the ultraviolet absorber in the second coat jointly intercept ultraviolet light. This can effectively protect the undercoat from ultraviolet light. Such joint interception eliminates the necessity of adding a large amount of the ultraviolet intercepting material only to one of the coats, or increasing the thickness of the first coat for blocking ultraviolet light. Accordingly, desired coloring properties can easily be obtained. Further, in the first coat, the metallic oxide nanoparticles are used to intercept ultraviolet light. This allows for maintaining the ultraviolet interception effect for a long time.

According to a preferred embodiment of the present invention, the second coat contains the nanoparticles, and the first coat contains a larger content of the nanoparticles than the second coat.

In general, increasing the content of the nanoparticles in a coat tends to cause its coating film to become opaque. However, in this preferred embodiment, even if the content of the nanoparticles is increased in the first coat, such nanoparticles less affect the coloring properties of the multilayer coating film because the first coat contains the coloring material. The second coat, which has a small content of the nanoparticles, allows light to be transmitted therethrough, easily. This is advantageous in making the coloring material of the first coat provide desired coloring properties. This also reduces the degree of the deterioration of the ultraviolet interception effect due to polishing.

According to another preferred embodiment of the present invention, the second coat contains the ultraviolet absorber, and a wavelength region in which each of the nanoparticles in the first coat exhibits the ultraviolet interception effect is broader in a high wavelength range than a wavelength region in which the ultraviolet absorber in the second coat exhibits the ultraviolet interception effect.

Light having a wavelength of 400 nm or less is generally referred to as “ultraviolet light.” Organic ultraviolet absorbers cannot effectively absorb light having a wavelength above 370 nm According to this embodiment, the first coat is provided with the nanoparticles exhibiting the ultraviolet interception effect in a wavelength region which is broader in a high wavelength range. This allows the nanoparticles in the first coat to intercept ultraviolet light having a higher wavelength range which cannot be intercepted by the ultraviolet absorber in the second coat.

According to another preferred embodiment, the first coat is configured as a base coat of the topcoat, and the second coat is configured as a clear coat of the topcoat. In this embodiment, in particular, if the second coat configured as the clear coat is provided with the ultraviolet intercepting nanoparticles, this advantageously prevents the clear coat from becoming opaque. In other words, both the base coat and the clear coat jointly intercept ultraviolet light, thereby being able to reduce an increase in the content of the nanoparticles in the clear coat. This advantageously prevents the clear coat from becoming opaque.

According to another preferred embodiment, the first coat is configured as an intermediate coat, and the second coat is configured as the base coat of the topcoat.

### Advantages of the Invention

According to the present invention, both the ultraviolet intercepting nanoparticles in the first coat and the ultraviolet intercepting nanoparticles and/or the ultraviolet absorber in the second coat jointly intercept ultraviolet light. This can effectively protect the undercoat from the ultraviolet light. As a result, it is unnecessary to add a large amount of the ultraviolet intercepting material only to one coat, or increase the thickness of the first coat for blocking ultraviolet light. This allows for easily obtaining desired coloring properties. On top of that, the first coat is provided with the metallic oxide nanoparticles to intercept ultraviolet light. This allows for maintaining the ultraviolet interception effect for a long time.

### BRIEF DESCRIPTION OF THE DRAWINGS

FIG. 1 is a cross-sectional view illustrating the configuration of a multilayer coating film according to a first embodiment.

FIG. 2 is a graph showing the light transmittance of an ultraviolet absorber and the light transmittance of a nanoparticle.

FIG. 3 is a graph showing a relationship between the thickness and light transmittance of a base coat in a situation where an ultraviolet absorber is added to only a clear coat.

FIG. 4 is a graph showing a relationship between the thickness and light transmittance of a base coat in a situation where the ultraviolet absorber is added to the clear coat and ZnO nanoparticles are added to the base coat.

FIG. 5 is a cross-sectional view illustrating the configuration of a multilayer coating film according to a second embodiment.

### DESCRIPTION OF EMBODIMENTS

Embodiments of the present invention will now be described with reference to the drawings. Note that the following description of preferred embodiments is merely illustrative in nature, and is not intended to limit the scope, applications, and use of the invention.

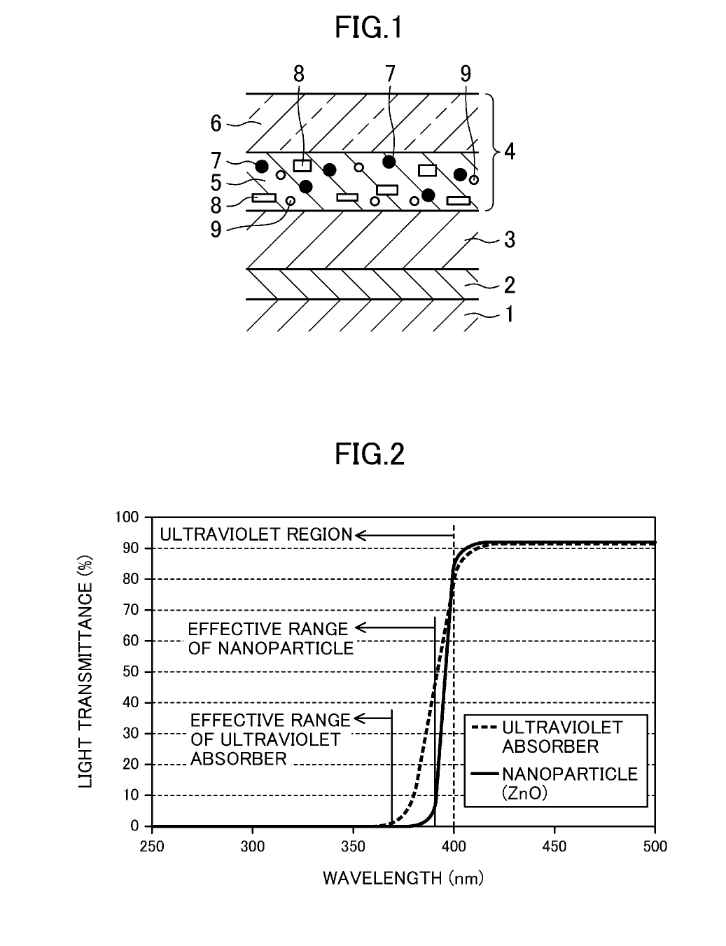

In the multilayer coating film illustrated in FIG. 1, the reference character 1 denotes a coated steel material (for example, an outer plate of a vehicle body). An undercoat 2 made of epoxy-based cationic electrodeposition paint is formed on this coated material 1. An intermediate coat 3 is stacked on this undercoat 2. This intermediate coat 3 has the ability to conceal the undercoat, and is formed to improve photo-deterioration resistance, chipping resistance, and coloring properties. A topcoat 4 is stacked on the intermediate coat 3.

The topcoat 4 is comprised of a base coat 5 and a clear coat 6 stacked on the base coat 5. The base coat 5 is made of a resin containing, e.g., a pigment 7 serving as a coloring material and a bright material 8 that are dispersed therein, and imparts coloring and design properties to the multilayer coating film. The clear coat 6 imparts weather resistance and abrasion resistance to the multilayer coating film.

The present invention is characterized in that the base coat 5 constituting a first coat contains metallic oxide nanoparticles 9 having an ultraviolet interception effect, and the clear coat 6 constituting a second coat contains the nanoparticles and/or an organic ultraviolet absorber (hereinafter simply referred to as “ultraviolet absorber”). That is, both the base coat 5 and the clear coat 6 jointly intercept ultraviolet light, thereby preventing deterioration of the undercoat 2 due to the ultraviolet light.

Alternatively, the intermediate coat 3 may contain the nanoparticles 9, and the base coat 5 may contain the nanoparticles and/or the ultraviolet absorber. In this case, the intermediate coat 3 is regarded as the first coat, and the base coat 5 stacked thereon is regarded as the second coat.

A case where the base coat 5 constitutes the first coat and the clear coat 6 constitutes the second coat will be described below.

### First Embodiment

FIG. 1 is a view illustrating one example where the base coat 5 contains the ultraviolet intercepting nanoparticles 9, and the clear coat 6 contains the ultraviolet absorber. Table 1 shows an example configuration of the topcoat to develop a white color.

TABLE 1

| | | Solid Mass Ratio % |
|---|---|---|
| Base Coat | Resin; Acrylic-based Resin | 45 |
| | Pigment; TiO₂ | 50 |
| | Ultraviolet Interception Material; | 5 |
| | ZnO Nanoparticles (D50 = 10 nm) | |

| | |
|---|---|
| Clear Coat | Mack Flow O-1600-2 |

Referring to Table 1, acrylic resin (an acid value of 20 mg KOH/g, a hydroxyl value of 75 mg KOH/g, a number-average molecular weight of 5000, a solid mass ratio of 60%) manufactured by NIPPONPAINT Co., Ltd., is used as an acrylic-based resin constituting the base coat 5. A ZnO nanoparticle dispersion (a solid mass ratio of 20%) manufactured by Sumitomo Osaka Cement Co., Ltd., is used as ZnO nanoparticles. Mack Flow 0-1600-2 constituting the clear coat 6 is an acrylic-based clear paint manufactured by NIPPONPAINT Co., Ltd and containing an ultraviolet absorber.

FIG. 2 shows the light transmittance of the ultraviolet absorber and the light transmittance of the ZnO nanoparticle. The wavelength region in which the ZnO nanoparticle exhibits the ultraviolet interception effect is broader in a high wavelength range than the wavelength region in which the ultraviolet absorber exhibits the ultraviolet interception effect. Thus, both the ZnO nanoparticles of the base coat 5 and the ultraviolet absorber of the clear coat 6 jointly intercept ultraviolet light. On top of that, the ZnO nanoparticles efficiently intercept ultraviolet light having a higher wavelength in which the ultraviolet absorber cannot sufficiently exhibit the interception effect.

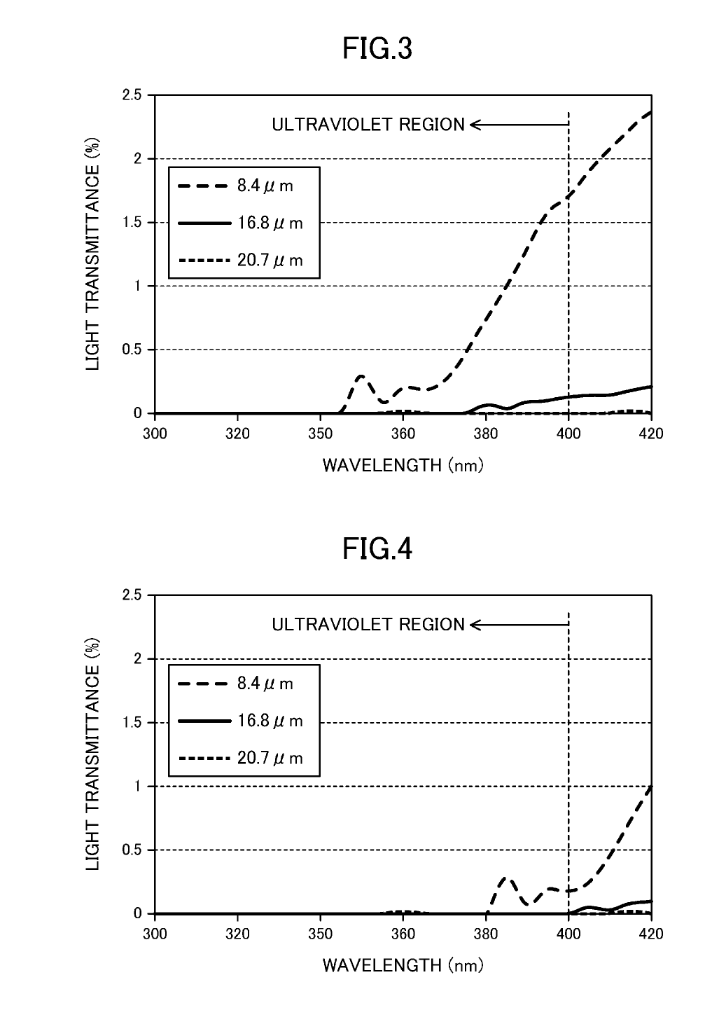

FIG. 3 shows a relationship between the thickness and light transmittance of the base coat 5 in a situation where the ultraviolet absorber is added to only the clear coat 6, and no ultraviolet absorber and no ZnO nanoparticle are added to the base coat 5. It shows that the ultraviolet interception effect cannot be sufficiently obtained in a high wavelength range (at a wavelength above 340 nm) within the ultraviolet region unless the thickness of the base coat 5 is increased. In particular, since the ultraviolet absorber deteriorates with time, the base coat 5 has to have a significantly large thickness to protect the undercoat 2. Such a larger thickness may cause an undesirable influence on the coloring properties of the base coat 5. This means that it is difficult to both intercept ultraviolet light and provide the coloring properties.

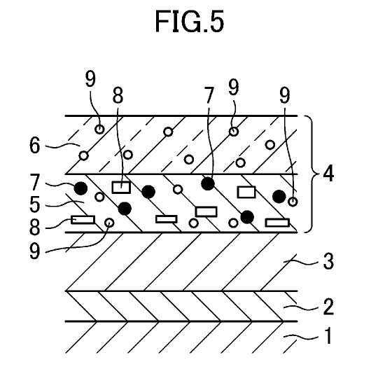

FIG. 4 is a graph showing a relationship between the thickness and light transmittance of the base coat 5 in a situation where the ultraviolet absorber is added to the clear coat 6 and the ZnO nanoparticles are added to the base coat 5 (the configuration of the coating film shown in Table 1). It shows that the addition of the ZnO nanoparticles to the base coat 5 allows for intercepting ultraviolet light having a wavelength of 380 nm or less even if the base coat 5 has a smaller thickness (a thickness of 8.4 μm). This shows that the coloring properties are easily adjusted by varying the thickness of the base coat 5 without reducing the ultraviolet interception effect.

### Second Embodiment

FIG. 5 is a view illustrating one example where each of the base coat 5 and the clear coat 6 contains the ultraviolet intercepting nanoparticles 9. Table 2 shows an example configuration of the coating film to develop a white color.

TABLE 2

| | | Solid Mass Ratio % |
|---|---|---|
| Base Coat | Resin; Acrylic-based Resin | 42 |
| | Pigment; TiO₂ | 50 |
| | Ultraviolet Interception Material; | 8 |
| | ZnO Nanoparticles (D50 = 10 nm) | |
| Clear Coat | Resin; Acrylic-based Resin | 98 |
| | Ultraviolet Interception Material; | 2 |
| | ZnO Nanoparticles (D50 = 10 nm) | |

In Table 2, the components constituting the base coat 5 are the same as those in the first embodiment. Acrylic resin manufactured by NIPPONPAINT Co., Ltd., is used as the acrylic-based resin of the clear coat 6, and the ZnO nanoparticle dispersion (a solid mass ratio of 20%) manufactured by Sumitomo Osaka Cement Co., Ltd., is used as ZnO nanoparticles, like the base coat 5.

The ZnO nanoparticles are white. If the clear coat 6 contains the ZnO nanoparticles at a large content, the clear coat 6 becomes opaque. Therefore, the clear coat 6 contains a smaller content of the ZnO nanoparticles than the base coat 5 to prevent itself from becoming opaque.

Both of the ultraviolet absorber and the ultraviolet intercepting nanoparticles may be added to the clear coat 6.

The coloring material of the first coat is not limited to the pigment. Alternatively, dyes may be used.

According to the above embodiments, the intermediate coat is provided between the undercoat and the topcoat. The present invention is applicable also to a multilayer coating film where the base coat is stacked directly on the undercoat without the intermediate coat.

### DESCRIPTION OF REFERENCE CHARACTERS

1 coated material

2 undercoat

3 intermediate coat

4 topcoat

5 base coat

6 clear coat

7 coloring material (pigment)

8 bright material

9 nanoparticle

1. A multilayer coating film comprising:
a first coat provided on or above an undercoat and containing a coloring material; and
a second coat stacked on the first coat, wherein
the first coat contains metallic oxide nanoparticles having an ultraviolet interception effect, and
the second coat contains at least one of metallic oxide nanoparticles having an ultraviolet interception effect or an organic ultraviolet absorber having an ultraviolet interception effect.

2. The multilayer coating film of claim 1, wherein
the second coat contains the nanoparticles, and
the first coat contains a larger content of the nanoparticles than the second coat.

3. The multilayer coating film of claim 1, wherein
the second coat contains the ultraviolet absorber, and
a wavelength region in which each of the nanoparticles in the first coat exhibits the ultraviolet interception effect is broader in a high wavelength range than a wavelength region in which the ultraviolet absorber in the second coat exhibits the ultraviolet interception effect.

4. The multilayer coating film of claim 2, wherein
the second coat contains the ultraviolet absorber, and
a wavelength region in which each of the nanoparticles in the first coat exhibits the ultraviolet interception effect is broader in a high wavelength range than a wavelength region in which the ultraviolet absorber in the second coat exhibits the ultraviolet interception effect.

5. The multilayer coating film of claim 1, wherein
a topcoat is provided above the undercoat with an intermediate coat interposed therebetween or on the undercoat without the intermediate coat, and
the first coat constitutes a base coat of the topcoat, and the second coat constitutes a clear coat of the topcoat.

6. The multilayer coating film of claim 2, wherein
a topcoat is provided above the undercoat with an intermediate coat interposed therebetween or on the undercoat without the intermediate coat, and
the first coat constitutes a base coat of the topcoat, and the second coat constitutes a clear coat of the topcoat.

7. The multilayer coating film of claim 3, wherein
a topcoat is provided above the undercoat with an intermediate coat interposed therebetween or on the undercoat without the intermediate coat, and
the first coat constitutes a base coat of the topcoat, and the second coat constitutes a clear coat of the topcoat.

8. The multilayer coating film of claim 4, wherein
a topcoat is provided above the undercoat with an intermediate coat interposed therebetween or on the undercoat without the intermediate coat, and
the first coat constitutes a base coat of the topcoat, and the second coat constitutes a clear coat of the topcoat.

9. A coated article comprising the multilayer coating film of claim 1.

10. A coated article comprising the multilayer coating film of claim 2.
